(19) United States
(12) Patent Application Publication
(10) Pub. No.: US 2014/0265825 A1
(43) Pub. Date: Sep. 18, 2014

(54) MERCURY VAPOR DISCHARGE LAMP AND METHOD FOR ITS MANUFACTURE

(71) Applicant: Heraeus Noblelight GmbH, Hanau (DE)

(72) Inventors: Burkard JUNG, Alzenau (DE); Erich ARNOLD, Mainz (DE)

(73) Assignee: Heraeus Noblelight GmbH, Hanau (DE)

(21) Appl. No.: 14/206,414

(22) Filed: Mar. 12, 2014

(30) Foreign Application Priority Data
Mar. 14, 2013 (DE) 10 2013 102 600.1

(51) Int. Cl. H01J 61/20; H01J 9/26

(52) U.S. Cl. CPC H01J 61/20; H01J 9/266
USPC 313/639; 445/26

(57) ABSTRACT

Conventional mercury vapor discharge lamps include a closed emitter tube made of quartz glass having an emitter tube end, a gas-tight seal in the region of the emitter tube end, and two electrodes arranged inside the emitter tube for generating a discharge in a discharge zone between the electrodes, as well as an amalgam reservoir. In order to provide a mercury vapor discharge lamp having an amalgam reservoir, which can be operated at high efficiency at variable irradiation power and also is easy and inexpensive to manufacture, an annular gap is formed in the region of the emitter tube end between a quartz glass tube and the emitter tube, and the amalgam reservoir is arranged inside the annular gap.

### BACKGROUND OF THE INVENTION

The invention relates to a mercury vapor discharge lamp comprising a closed emitter tube made of quartz glass having an emitter tube end, a gas-tight seal in the region of the emitter tube end, and two electrodes arranged inside the emitter tube for generating a discharge in a discharge zone between the electrodes, as well as an amalgam reservoir.

Moreover, the invention relates to a method for the manufacture of a mercury vapor discharge lamp comprising the procedural steps:
(a) providing an emitter tube made of quartz glass having an emitter tube end;
(b) installing electrodes for generating a discharge in a discharge zone between the electrodes; and
(c) closing the emitter tube end.

Customary mercury vapor discharge lamps comprise a cylindrical emitter tube made of quartz glass, in which two electrodes are arranged. The emitter tube is closed in gas-tight manner at both emitter tube ends by pinches, through which a power supply is routed for electrical contacting of the electrodes. The emitter tube is filled with a filling gas, for example a noble gas. Moreover, an amalgam reservoir is introduced into the emitter tube.

Mercury vapor discharge lamps having an amalgam reservoir show an emission spectrum with characteristic lines at 185 nm (VUV radiation) and/or 254 nm (UV-C radiation). They are used, for example, for disinfection of liquids, air, and surfaces. Preferred applications of UV-C radiation-emitting mercury vapor discharge lamps are, for example, the disinfection of drinking water or the disinfection of packaging materials. VUV radiation-emitting mercury vapor discharge lamps are used to advantage in the semiconductor industry in the production of ultra-pure process waters or for fat degradation in industrial extractor hoods.

The radiation power of mercury vapor discharge lamps is a function of the vapor pressure of mercury in the discharge space and thus of the operating temperature of the lamp. High radiation efficiency is attained if the mercury vapor pressure generated in the discharge space is as optimal and as constant as possible. Accordingly, for example, the optimal mercury vapor pressure for the generation of UV-C radiation (254 nm) is approx. 0.8 Pa.

In mercury vapor discharge lamps having an amalgam reservoir, a balance between the alloyed mercury present in the amalgam reservoir and the “free” mercury in the emitter tube is established and limits and defines the mercury vapor pressure inside the emitter tube.

However, even if an amalgam reservoir is used, the mercury vapor pressure inside the emitter tube still depends on the temperature, in particular on the temperature of the amalgam reservoir. Emitters operated at different power values have a different emitter tube internal wall temperature depending on their operating condition. An amalgam reservoir arranged between the electrodes on the internal wall of the emitter tube therefore has a different temperature depending on operating conditions, which is associated with a varying mercury vapor pressure inside the emitter tube. Operating the lamp at different power values or ambient conditions, this causes the generation of radiation to not take place at optimal efficiency.

To enable the operation of mercury vapor discharge lamps with an optimized mercury vapor pressure in any event, it has been proposed instead to arrange the amalgam reservoir in the discharge zone in or in the vicinity of the dead space of the electrodes. Having an amalgam reservoir arranged as described, for example an additional heating by the electrode or by an additional heating element, allows an optimized temperature of the amalgam reservoir and thus a constant mercury vapor pressure to be set in the discharge space.

Accordingly, from European Patent EP 1 984 935 B1 is known a low pressure mercury vapor discharge lamp having an amalgam reservoir, in which the amalgam reservoir is arranged outside the discharge zone. For heating the amalgam reservoir to an optimal temperature, a heating element operated by an electronic circuit is provided. The electrical heating of the heating element is effected in this context by a heating current that is generated as a function of the dimming stage of the mercury vapor discharge lamp.

However, the electrodes of mercury vapor discharge lamps are often made of tungsten. The electronic work function of electrodes made of tungsten is high, being approx. 6.5 eV in the case of pure tungsten. In order to lower the work function, tungsten electrodes are therefore often coated with an emitter paste made of carbonates, usually made of SrCO₃, BaCO₃, and CaCO₃, during production, which are subsequently converted into alkaline earth oxides by thermal means. The work function of a tungsten electrode coated as described is reduced to approx. 1.2 eV. This simplifies the ignition of the mercury vapor discharge lamp and reduces the electrode power dissipation in operation. However, uncoated and, in particular, coated electrodes alike tend to lose electrode particles by vaporization or sputtering processes during operation of the mercury vapor discharge lamp. These particles condense in the dead space of the electrodes. Electrode particles that are deposited on an amalgam reservoir arranged in the dead space of the electrodes impair the function of the amalgam reservoir and contribute to the reduction of the service life of the mercury vapor discharge lamp.

U.S. Pat. No. 7,816,849 B2 also teaches a low pressure mercury vapor discharge lamp having an amalgam reservoir that is allocated to the dead space of the electrodes. The mercury vapor discharge lamp known from this reference has an external amalgam container, in the form of a pipe socket, connected to the cylinder jacket of the emitter tube outside the discharge zone. For regulation of the temperature of the amalgam, the amalgam container is provided with a heating and cooling element, which enables operation of the discharge lamp at different illumination intensities and dimming stages.

As a matter of principle, a mercury vapor discharge lamp having an external amalgam container, in the from of a pipe socket, welded to the external jacket of the emitter tube is mechanically fragile. Specifically, the amalgam container can break off of the emitter tube, even when exposed to low mechanical forces, and thus lead to destruction of the mercury vapor discharge lamp. Moreover, an amalgam reservoir being arranged in an external amalgam container is comparatively distant from the electrical current supply of the electrodes, such that an additional heating element is required to heat the amalgam reservoir. Moreover, the amalgam reservoir is not affixed and is freely mobile inside the socket, such that it is exposed to different temperatures depending on its exact location. However, the temperature of the amalgam reservoir has a crucial influence on the mercury vapor pressure inside the fluorescent tube and thus on the efficiency of the generation of radiation.

### BRIEF SUMMARY OF THE INVENTION

The invention is therefore based on the object to devise a mercury vapor discharge lamp having an amalgam reservoir, which can be operated at variable irradiation power and at high efficiency and comprises high mechanical stability and, in addition, is easy and inexpensive to manufacture.

Moreover, the invention is also based on the object to devise a simple and inexpensive method for the manufacture of the mercury vapor discharge lamp.

Referring to the mercury vapor discharge lamp, the object is met according to the invention based on a mercury vapor discharge lamp having the features mentioned above, in that an annular gap is formed in the region of the emitter tube end between a quartz glass tube and the emitter tube and in that the amalgam reservoir is arranged inside the annular gap.

The mercury vapor discharge lamp according to the invention comprises two modifications as compared to the prior art in this field, one of which relates to the formation of an annular gap in the region of the emitter tube end and the other relates to arranging the amalgam reservoir inside the annular gap.

According to the invention, a tube-in-tube arrangement of a quartz glass tube and the emitter tube is provided in the region of the emitter tube end, wherein an annular gap is formed between quartz glass tube and emitter tube. The annular gap is circumferential or interrupted. Emitter tube and quartz glass tube have a cylinder-shaped design or depart from the design as they can, for example, be conical in shape. Preferably, quartz glass tube and emitter tube extend in a concentric manner in a cross-sectional plane.

The annular gap is limited by annular gap walls; it extends, for example, between the external wall of the quartz glass tube and the internal wall of the emitter tube or between the internal wall of the quartz glass tube and the external wall of the emitter tube. The annular gap is fully or partly open on one or two sides. In this context, the quartz glass tube can be connected to the emitter tube at distinct spots or via a surface. Preferably, the quartz glass tube is arranged outside of the discharge zone, but it can project into the discharge zone just as well. Referring to a quartz glass tube that projects into the discharge zone, the quartz glass tube comprises a first section allocated to the discharge zone and a second section allocated to a region outside of the discharge zone. The amalgam reservoir can be arranged in the first or in the second section. Preferably, the amalgam reservoir is arranged in the vicinity of the electrode. An amalgam reservoir arranged in the first section has a high temperature during operation of the mercury vapor discharge lamp and can therefore be adjusted to an optimal temperature very rapidly. Preferably, the amalgam is arranged in the second section, outside of the discharge zone. An amalgam reservoir of this type has a lower temperature during operation of the mercury vapor discharge lamp, such that an optimized amalgam reservoir temperature can be adjusted in a large temperature range.

The opening of the annular gap is arranged outside the discharge zone or projects into the same. The discharge zone has a higher temperature as compared to the end sections of the emitter tube arranged outside the discharge zone. An annular gap opening that is arranged inside the discharge zone contributes to increased heat transport into the quartz glass tube. Since the heat transport also depends on the operating and dimming condition of the mercury vapor discharge lamp in this case, it has proven efficient to arrange the opening of the annular gap outside the discharge zone.

The amalgam reservoir is positioned inside the annular gap. The amalgam that liquefies during operation of the discharge lamp is preferably held inside the discharge zone by capillary forces. Arranging the amalgam reservoir inside the annular gap as specified, the reservoir is in fluid communication with the inside of the emitter tube only through the openings of the annular gap. As a result, the amalgam reservoir has comparatively little surface in direct contact with the inside of the emitter tube. Rather, the annular gap walls being arranged on both sides protect the amalgam reservoir from possible deposition of particles condensing in the dead space of the electrodes. Arranging the amalgam reservoir such that it is protected in an annular gap allows it to be arranged in direct vicinity of the electrode without the service life of the lamp being significantly impaired by sputtering processes taking place on the electrode. Arranging the amalgam reservoir in the vicinity of the electrodes renders a separate heating and cooling facility dispensable. Due to the proximity to the dead space of the electrodes, a thermal influence on the amalgam reservoir can be provided by an additional heating current flowing through the electrode.

In contrast to a mercury vapor discharge lamp having an external amalgam container connected to the emitter tube, the mercury vapor discharge lamp according to the invention comprises an amalgam reservoir arranged inside the emitter tube that is protected from the external influence of mechanical forces. An external amalgam container may be exposed to mechanical stresses during manufacture, transport or operation, which can, for example, lead to fracture of the external amalgam container and, as a result, to the destruction of the mercury vapor discharge lamp. The mercury vapor discharge lamp according to the invention dispenses with an external amalgam container. Instead, the amalgam reservoir is arranged inside the discharge space, where it is more protected from external mechanical influences. A mercury vapor discharge lamp of this type is therefore characterized by high mechanical stability and a long service life.

A first preferred embodiment of the mercury vapor discharge lamp according to the invention has the quartz glass tube connected to the emitter tube, preferably by fusing them by melting.

The quartz glass tube and the emitter tube being fused by melting allows the annular gap to be adjusted in reproducible manner. The fusing by melting guarantees that a connection of quartz glass tube and emitter tube shows high mechanical stability and contributes to the annular gap not undergoing significant changes during operation of the mercury vapor discharge lamp.

It has proven expedient for the annular gap to be closed on one side.

The distance between annular gap opening and amalgam reservoir has an influence on the fixation of the amalgam reservoir inside the annular gap. With an annular gap that is open on both sides, the amalgam reservoir can leak from the annular gap at both annular gap openings as a matter of principle. An annular gap that is closed on one side is advantageous in that the amalgam reservoir can preferably be positioned in the region of the closed annular gap opening, such that the amalgam reservoir is situated at a larger distance from the annular gap opening than is the case with an annular gap of equal size that is open on both sides. This retains the amalgam reservoir better in the annular gap. Moreover, having an annular gap that is closed on one side enables fixation of the amalgam reservoir while keeping the longitudinal extension of the annular gap small. Accordingly, an annular gap that is closed on one side contributes to a compact design of the mercury vapor discharge lamp.

Another preferred embodiment of the mercury vapor discharge lamp according to the invention provides the annular gap to be formed by an external wall of the quartz glass tube and an internal wall of the emitter tube.

The annular can be formed just as well by the external wall of the quartz glass tube and the internal wall of the emitter tube as by the external wall of the emitter tube and the internal wall of the quartz glass tube. The former variant is advantageous in that it does not lead to a significant increase of the external diameter of the emitter tube. This, in particular, enables the manufacture of a panel radiator of high radiation power, in which multiple emitters are arranged with their emitter tubes being positioned right next to each other.

A further preferred modification of the mercury vapor discharge lamp according to the invention provides the quartz glass tube to be fused by melting to the front face of the emitter tube, while forming an annular gap and provides the quartz glass tube to be closed at the end facing away from the discharge zone.

Due to the front face of the emitter tube being fused by melting to the quartz glass tube, the quartz glass tube contributes to the gas-tight seal of the emitter tube. The end of the quartz glass tube facing away from the emitter tube preferably has a gas-tight seal provided on it, for example in the form of a crimping, through which an electrical current supply can be routed for contacting of an electrode.

It has proven expedient for the quartz glass tube to comprise a longitudinal axis of the tube and the emitter tube to comprise a longitudinal axis of the emitter tube, and for the longitudinal axis of the tube and longitudinal axis of the emitter tube to extend such as to be coaxial.

The quartz glass tube and the emitter tube being coaxial enables the annular gap to be even—as seen in a cross-section—with equal gap widths. This causes the quartz glass tube and the emitter tube to extend in concentric manner in the cross-sectional plane. The size of the annular gap has an influence on the position of the amalgam reservoir and its spatial location and/or isothermal position inside the annular gap. Specifically, an annular gap that is even when seen in a cross-sectional view is suitable for effective fixation of the amalgam reservoir inside the annular gap.

It has proven to be expedient for the gap width of the annular gap to be in the range of 0.5 to 5 mm, preferably in the range of 1 mm to 4 mm.

The gap width of the annular gap has an influence on the capillary forces acting on an amalgam reservoir that is arranged inside the annular gap. A gap width in the range specified above is well-suited to retain the amalgam reservoir inside the annular gap. It is difficult to position the amalgam reservoir in an annular gap with a gap width of less than 0.5 mm. The effect of the capillary forces on the amalgam reservoir is reduced if the gap width of the annular ring exceeds 5 mm.

In an advantageous embodiment of the mercury vapor discharge lamp according to the invention, the longitudinal extension of the annular gap is in the range of 5 mm to 30 mm.

An annular gap having a longitudinal extension in the range specified above is well-suited for retaining in the gap an amalgam that liquefies during operation of the mercury vapor discharge lamp. Moreover, an annular gap of this type is easy and inexpensive to manufacture. If the length of the annular gap is less than 5 mm, the distance of the amalgam reservoir to the annular gap opening is small such that electrode particles, in particular, can deposit more easily on the amalgam reservoir. The length of the annular gap being more than 30 mm contributes to a comparatively large non-illuminated region at the emitter tube ends and is an impediment for a compact design of the mercury vapor discharge lamp.

It has proven to be advantageous for the quartz glass tube and the emitter tube each to form one annular gap wall, and for one of the annular gap walls to comprise a circumferential groove.

The amalgam reservoir can be retained in an annular gap due to the capillary effect. This effect depends on the surface tension of the amalgam and the interfacial tension of amalgam and quartz glass. The size and structure of the surface play a role as well in this context. An annular gap wall that is provided with a groove has a larger surface than an annular gap wall with no groove. The groove prevents the liquid amalgam from leaking and contributes to good fixation of the amalgam inside the annular gap.

It has proven expedient in this context for the groove to have a depth in the range of 0.5 mm to 1 mm and a cross-sectional area of the groove to be in the range of 0.5 mm² to 2 mm².

If the depth of the groove is less than 0.5 mm, the effect of having a groove on the fixation of the amalgam reservoir inside the annular gap is lost. A depth of the groove being more than 1 mm can contribute to the possible formation of a breakage site which impairs the mechanical stability of the mercury vapor discharge lamp.

The cross-section of the groove can take any of various geometries. The groove can, for example, be V-shaped, rectangular or trapezoidal in shape. Preferably, the groove is provided to be trapezoidal, since this geometry, in particular, guarantees a good amalgam reservoir retention capability. A cross-sectional area of the groove of less than 0.5 mm² contributes little to the fixation of the amalgam reservoir. A cross-sectional area of the groove of more than 2 mm² is difficult to manufacture and leads to high manufacturing costs.

Another also preferred modification provides the quartz glass tube and the emitter tube to each form one annular gap wall and provides a gold coating to be applied to one of the annular gap walls.

A gold coating is well-suited for fixing the amalgam reservoir, since amalgam wets the surface of gold. Having a gold coating applied to one of the annular gap walls enables fixation of the amalgam reservoir inside the annular gap. Moreover, the gold coating allows the position of the amalgam reservoir inside the annular gap to be defined. Fixation of the amalgam reservoir on the gold coating is attained by situating the amalgam reservoir in the vicinity of the gold coating and melting it by heating it briefly.

A preferred embodiment of the mercury vapor discharge lamp provides a heating facility for temperature control of the amalgam reservoir to be allocated to the annular gap.

The heating facility is provided for adjusting an optimized amalgam temperature; it can be allocated to the external surface of the mercury vapor discharge lamp. In this case, the heating facility surrounds the external surface in annular manner or is allocated to a certain part-surface of the external surface that is operatively connected to the amalgam reservoir.

Referring to the method for manufacturing a mercury vapor discharge lamp, the technical object presented above is met based on a method having the features described above in that the emitter tube and the quartz glass tube are slid one into the other before closing the emitter tube end and in that the quartz glass tube is fused by melting to the front face of the emitter tube while forming an annular gap.

According to the method according to the invention, the manufacture of the mercury vapor discharge lamp is based on an emitter tube and a quartz glass tube. First, quartz glass tube and emitter tube are slid one into the other, whereby a tube-in-tube arrangement is produced. Preferably, the external diameter of the quartz glass tube is smaller than the internal diameter of the emitter tube. The quartz glass tube and one front face of the emitter tube are then fused by melting. In this context, the longitudinal axes of the quartz glass tube and emitter tube are preferably in a coaxial arrangement with respect to each other, such that an annular gap is formed that is as even as possible. Then, the emitter tube end is closed.

The quartz glass tube and the emitter tube being in a tube-in-tube arrangement allows an annular gap limited by annular gap walls to be obtained that extends, for example, between the external wall of the quartz glass tube and the internal wall of the emitter tube or between the internal wall of the quartz glass tube and the external wall of the emitter tube. The annular gap can be closed on one side, for example, by connecting the quartz glass tube to the emitter tube at distinct spots or via a surface. The opening of the annular gap is arranged outside the discharge zone or projects into the same.

Last, the amalgam reservoir is positioned inside the annular gap. The amalgam that liquefies during operation of the discharge lamp is preferably held inside the annular gap by capillary forces or gold spot. Arranging the amalgam reservoir inside the annular gap as specified, the reservoir is in fluid communication with the inside of the emitter tube only through the openings of the annular gap. As a result, the amalgam reservoir has comparatively little surface in direct contact with the inside of the emitter tube. Rather, the annular gap walls being arranged on both sides protect the amalgam reservoir from possible deposition of particles condensing in the dead space of the electrodes. Moreover, the amalgam reservoir can be positioned in the immediate vicinity of the electrodes due to the presence of the annular gap without the service life of the lamp being significantly impaired by a sputtering process taking place on the electrodes. In the simplest case, it is feasible to dispense with a separate heating and cooling facility due to the spatial proximity of the amalgam reservoir to the electrodes, since a thermal influence on the amalgam reservoir can be provided by an additional heating current applied to the electrode.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic, cross-sectional, truncated view showing one end of an embodiment of a mercury vapor discharge lamp according to the invention having an amalgam reservoir arranged in an annular gap.

### DETAILED DESCRIPTION OF THE INVENTION

FIG. 1 shows a schematic view of an embodiment of the mercury vapor discharge lamp according to the invention, which, as a whole, has reference number 1 assigned to it. To simplify matters, FIG. 1 shows only one end-section of the mercury vapor discharge lamp 1. The other end-section is designed alike. It is feasible to depart from the end-section shown in another embodiment. The mercury vapor discharge lamp 1 is suitable for use in drinking water disinfection. It is characterized by a specific power per unit length of the emitter tube of 4 W/cm.

The low pressure mercury vapor discharge lamp 1 comprises an emitter tube 2 made of quartz glass having a longitudinal axis 12 of the emitter tube and two electrodes 7 arranged inside the emitter tube 2, and an amalgam reservoir 6. The emitter tube 2 is closed in gas-tight manner on both emitter tube ends by a seal and is filled with a noble gas mixture (argon/neon). In an alternative embodiment, the emitter tube is filled with argon or neon. It has an external diameter of 38 mm and an internal diameter of 35 mm. The length of the emitter tube 2 is 100 cm. In the region of the emitter tube ends, the front face of the emitter tube 2 is fused by melting to a quartz glass tube 3 that has been inserted into the emitter tube 2. The external diameter of the quartz glass tube 3 is 32 mm and the internal diameter is 29 mm. The quartz glass tube comprises a longitudinal axis 13 of the tube. Emitter tube 2 and quartz glass tube 3 are arranged appropriately such that the longitudinal axis 12 of the emitter tube and the longitudinal axis 13 of the tube extend such as to be coaxial. The tube-in-tube arrangement of emitter tube 2 and quartz glass tube 3 forms an annular gap 5 between the external wall of the quartz glass tube 3 and the internal wall of the emitter tube 2. Since the external wall of the quartz glass tube 3 is fused by melting to the front face of the emitter tube 2 in circumferential manner, the annular gap 5 is closed on one end.

The annular gap 5 has a gap width 14 of 1.5 mm and a longitudinal extension 15 of 18 mm. The amalgam reservoir 6 is arranged inside the annular gap. The amalgam reservoir 6 is held inside the annular gap 5 by adhesion forces and capillary forces. A further contribution to this effect is made by a circumferential groove 4 that has been applied to the external wall of the quartz glass tube 3 in the region of the annular gap 5. The groove 4 has a trapezoidal cross-section with a cross-sectional area of 0.5 mm² and a depth of the groove of 0.5 mm. In an alternative embodiment (not shown), the groove 4 is applied to the internal surface of the emitter tube 2. In another alternative embodiment (not shown), a gold coating is applied at distinct spots to the external wall of the quartz glass tube 3 or to the internal wall of the emitter tube 2 for fixation of the amalgam reservoir.

Arranging the amalgam reservoir 6 inside the emitter tube 2 has an influence on the efficiency of the radiation yield. This is a function, in particular, of the mercury vapor pressure inside the emitter tube 2. The mercury vapor pressure is influenced by the temperature of the amalgam reservoir 6. In order to be able to provide an optimized mercury vapor pressure even at varying operating power values and ambient conditions, the amalgam reservoir 6 is arranged outside the discharge zone 16 defined by the electrodes 7. The electrode 7 comprises a coil 7a made of tungsten that has been provided with a coating 7b made of alkaline earth oxides. The coating 7b effects a reduction of the electronic work function rendering the mercury vapor discharge lamp 1 easier to ignite and operate.

In order to be able to adjust the temperature of the amalgam reservoir 6 by an additional heating current flowing through the electrode 7, the amalgam reservoir 6 is arranged in the vicinity of the electrode 7. Arranging the amalgam reservoir inside the annular gap 5 contributes to the amalgam reservoir 6 being shielded by the quartz glass tube 3, such that particles of coating material or tungsten that may detach from the electrode 7 by evaporation or sputtering processes cannot deposit on the amalgam reservoir. The quartz glass tube 3 therefore also contributes to a long service life of the mercury vapor discharge lamp 1.

Finally, the quartz glass tube 3 comprises a first front face 8 facing the emitter tube 2 and a second front face 9 facing away from the emitter tube 2, whereby the first front face 8 has the annular gap opening allocated to it by which the annular gap 5 is in fluid communication with the inside of the emitter tube 2. The second front face 9 of the quartz glass tube 3 is closed in gas-tight manner. This region has a gas-tight seal 10 arranged in it in the form of a pinch through which an electrical current supply 11 is routed for electrical contacting of the electrode 7.

In the following, the method according to the invention for manufacturing a mercury vapor discharge lamp is explained in exemplary manner based on FIG. 1. For simplification, only the closing of one of the emitter tube ends is described. The closing of the second emitter tube end takes place in analogous manner.

First, a cylinder-shaped emitter tube 2 made of quartz glass having a first and a second emitter tube end, and a quartz glass tube 3 are provided. The emitter tube 2 has an internal diameter of 35 mm and an emitter tube length of 100 cm. The external diameter of the quartz glass tube 3, being 32 mm, is smaller than the internal diameter of the emitter tube 2. The length of the quartz glass tube 3 is 55 mm. First, a circumferential groove 4 extending like a ring and having a groove depth of 0.5 mm and a trapezoidal cross-sectional area of the groove of 0.5 mm² is generated on the external wall of the quartz glass tube 3.

Then, the emitter tube 2 and the quartz glass tube 3 are slid one into the other in coaxial manner such that quartz glass tube 3 and emitter tube 2 overlap over a length of 20 mm. Due to the coaxial tube-in-tube arrangement of emitter tube 2 and quartz glass tube 3, an annular gap 5 with a gap width of approx. 1.5 mm is generated in between these. Subsequently, the front face of the emitter tube is fused by melting on one side to the quartz glass tube 3 leaving the annular gap 5 in place, such that the annular gap 5, seen in the direction toward the inside of the emitter tube, is open on one end.

Subsequently, the components of the electrical current supply, namely contact wires and metal foil are welded to each other. The welded electrical current supply is then connected to the electrode 7 and is inserted into the emitter tube 2 proceeding through the front face of the quartz glass tube facing away from the emitter tube.

The end of the quartz glass tube 3 is closed by pinching at high temperature (2,000° C.) to produce a gas-tight seal. The metal foil and parts of the contact wires are thus embedded in gas-tight manner in the pinch.

Finally, the emitter tube 2 is heated and the amalgam reservoir 6 and argon as the filling gas are introduced into the emitter tube 2 through a quartz glass socket (not shown) that is connected to the emitter tube 2. The socket is subsequently removed by melting it.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A mercury vapor discharge lamp comprising a closed emitter tube made of quartz glass having an emitter tube end, a gas-tight seal in a region of the emitter tube end, two electrodes arranged inside the emitter tube for generating a discharge in a discharge zone between the electrodes, an amalgam reservoir, and a quartz glass tube spaced from the emitter tube to form an annular gap in a region of the emitter tube end between the quartz glass tube and the emitter tube, wherein the amalgam reservoir is arranged inside the annular gap.

2. The mercury vapor discharge lamp according to claim 1, wherein the quartz glass tube is connected to the emitter tube.

3. The mercury vapor discharge lamp according to claim 2, wherein the quartz glass tube is fused to the emitter tube by melting.

4. The mercury vapor discharge lamp according to claim 1, wherein the annular gap is closed on one end.

5. The mercury vapor discharge lamp according to claim 1, wherein the annular gap is formed by an external wall of the quartz glass tube and an internal wall of the emitter tube.

6. The mercury vapor discharge lamp according to claim 1, wherein the quartz glass tube is fused by melting to a front face of the emitter tube while forming the annular gap and the quartz glass tube is closed at an end facing away from the discharge zone.

7. The mercury vapor discharge lamp according to claim 1, wherein the quartz glass tube has a longitudinal axis and the emitter tube has a longitudinal axis extending coaxially with the longitudinal axis of the emitter tube.

8. The mercury vapor discharge lamp according to claim 1, wherein the annular gap has a gap width in a range of 0.5 to 5 mm.

9. The mercury vapor discharge lamp according to claim 8, wherein the annular gap has a gap width in a range of 1 mm to 4 mm.

10. The mercury vapor discharge lamp according to claim 1, wherein the annular gap has a longitudinal extension in a range of 5 mm to 30 mm.

11. The mercury vapor discharge lamp according to claim 1, wherein the quartz glass tube and the emitter tube each form one annular gap wall, and wherein one of the annular gap walls comprises a circumferential groove.

12. The mercury vapor discharge lamp according to claim 11, wherein the groove has a groove depth in a range of 0.5 mm to 1 mm and a cross-sectional area of the groove in a range of 0.25 mm² to 2 mm².

13. The mercury vapor discharge lamp according to claim 1, wherein the quartz glass tube and the emitter tube each form one annular gap wall and wherein a gold coating is applied to one of the annular gap walls.

14. The mercury vapor discharge lamp according to claim 1, further comprising a heating facility for temperature control of the amalgam reservoir allocated to the annular gap.

15. The mercury vapor discharge lamp according to claim 1, wherein the amalgam reservoir is arranged outside the discharge zone.

16. A method for producing a mercury vapor discharge lamp comprising the following procedural steps:
(a) providing an emitter tube made of quartz glass having an emitter tube end,
(b) installing electrodes for generating a discharge in a discharge zone between the electrodes;
(c) providing a quartz glass tube spaced from the emitter tube by sliding one of the emitter tube and the quartz glass tube into the other tube while forming an annular gap between the tubes; and
(d) closing the emitter tube end after step (c) by fusing the quartz glass tube by melting to a front face of the emitter tube.
